(19) United States
(12) Patent Application Publication
(10) Pub. No.: US 2026/0001201 A1
(43) Pub. Date: Jan. 1, 2026

(54) Recalibration of a Torque Measurement Device with Recalibration Interval Prediction

(71) Applicant: Apex Brands, Inc., Apex, NC (US)

(72) Inventors: Bin Sun, Shanghai (CN); Henglian Luo, Shanghai (CN)

(21) Appl. No.: 19/105,883

(22) PCT Filed: Aug. 24, 2022
(86) PCT No.: PCT/CN2022/114460

§ 371 Date: Feb. 24, 2025

(51) Int. Cl. B25B 23/142

(52) U.S. Cl. CPC B25B 23/1425

(57) ABSTRACT

A method is provided for recalibrating an torque measurement device configured to determine a torque value of an applied torque using a calibration function derived during a calibration of the torque measurement device. The method includes performing a recalibration of the torque measurement device in which a second calibration function is derived and written to the torque measurement device (502). The method includes determining a deviation in the torque value determined using the calibration function relative to the second calibration function (504). The method includes predicting an interval from the recalibration to a next recalibration of the torque measurement device, for a different deviation over the next interval, based on the deviation, the different deviation, and the interval from the calibration to the recalibration (506). And the method includes outputting an indication of the interval from the recalibration to the next recalibration (508).

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

A number of programs in which a torque wrench is used include periodic recalibration to keep the torque wrench within specification in that the torque wrench is accurate to within a threshold value. The interval between recalibrations is often preset, but it may not accurately reflect when recalibration is needed for a particular torque wrench. In some cases, a torque wrench may be recalibrated well before the torque wrench is out of specification (the recalibration being unnecessary at the time). In other cases, a torque wrench may not be recalibrated until well after the torque wrench is out of specification (the recalibration being past necessary at the time). It would therefore be desirable to have a system and method that addresses this issue, as well as other possible issues.

### BRIEF SUMMARY

Example implementations of the present disclosure are directed to an apparatus for recalibrating an electronic torque wrench or other torque measurement device with recalibration interval prediction. According to various example implementations, during recalibration of the torque measurement device, an apparatus such as the torque measurement device itself or a torque tester is configured to predict an interval from the recalibration to a next recalibration, which is more accurately representative of when the torque measurement device reaches the point at which recalibration is needed to keep the torque measurement device within specification (or within another, desired accuracy of the torque measurement device). The an indication of the interval may be output, and time or use of the torque measurement device may be tracked to determine when the torque measurement device reaches the interval, or when the torque measurement device is within a threshold of the interval.

The present disclosure includes, without limitation, the following example implementations.

Some example implementations provide an apparatus for recalibrating an torque measurement device configured to determine a torque value of an applied torque using a calibration function derived during a calibration of the torque measurement device, the apparatus comprising: a memory configured to store computer-readable program code; and processing circuitry configured to access the memory, and execute the computer-readable program code to cause the apparatus to at least: perform a recalibration of the torque measurement device in which a second calibration function is derived and written to the torque measurement device; determine a deviation in the torque value determined using the calibration function relative to the second calibration function; predict an interval from the recalibration to a next recalibration of the torque measurement device, for a different deviation over the next interval, based on the deviation, the different deviation, and the interval from the calibration to the recalibration; and output an indication of the interval from the recalibration to the next recalibration.

Some example implementations provide a method of recalibrating an torque measurement device configured to determine a torque value of an applied torque using a calibration function derived during a calibration of the torque measurement device, the method comprising: performing a recalibration of the torque measurement device in which a second calibration function is derived and written to the torque measurement device; determining a deviation in the torque value determined using the calibration function relative to the second calibration function; predicting an interval from the recalibration to a next recalibration of the torque measurement device, for a different deviation over the next interval, based on the deviation, the different deviation, and the interval from the calibration to the recalibration; and outputting an indication of the interval from the recalibration to the next recalibration.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of an apparatus for determining an applied torque, and that may correspond to the electronic torque wrench of FIG. 1, according to some example implementations;

FIG. 3 is a graph of a calibration function, according to some example implementations;

FIG. 4 illustrates a system for calibrating a torque measurement device, according to various example implementations;

FIGS. 5A, 5B, 5C, 5D, SE and 5F are flowcharts illustrating various steps in a method of recalibrating an torque measurement device, according to various example implementations; and

FIG. 6 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

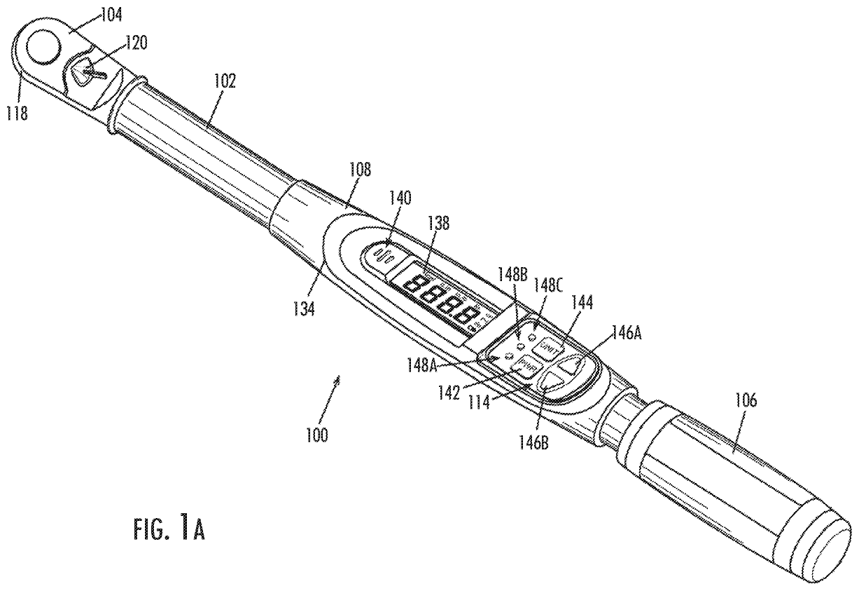

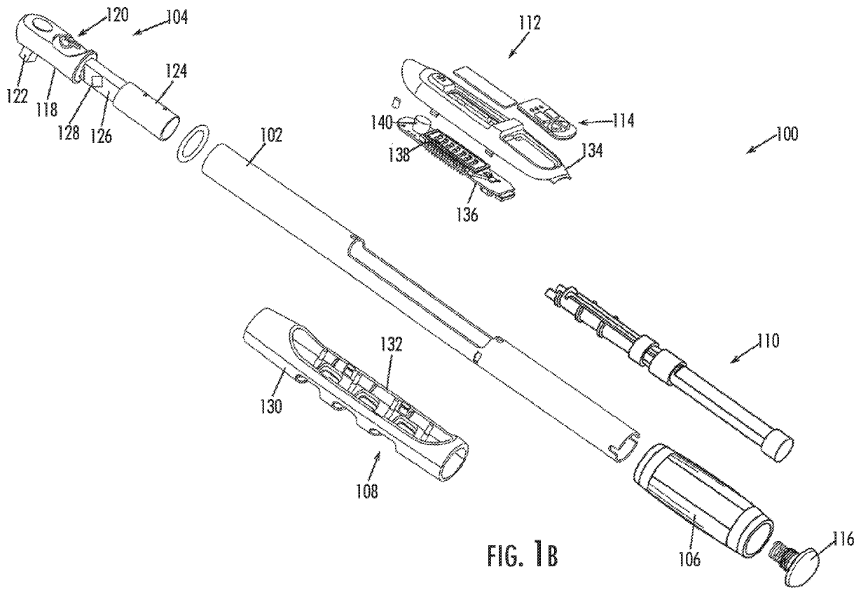

Example implementations of the present disclosure relate generally to torque application and measurement devices. Example implementations will primarily be described in the context of an electronic torque wrench. Other examples of suitable torque measurement devices include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a male square drive or boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

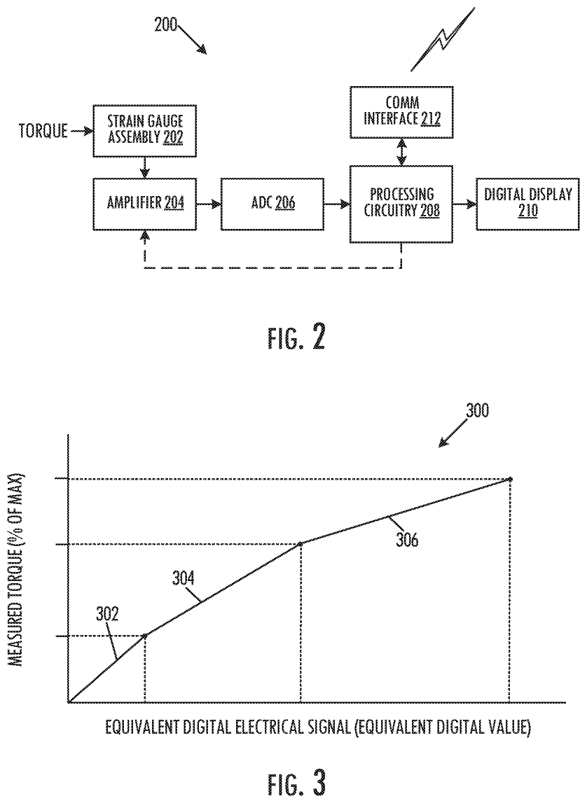

FIG. 2 illustrates a torque measurement device 200 for determining a torque value of an applied torque, according to some example implementations. The torque measurement device may be embodied in a number of different manners, and in some examples, the torque measurement device is an electronic torque wrench such as electronic torque wrench 100. In other examples, the torque measurement device is a torque tester, torque meter, torque transducer or the like. As shown, the torque measurement device includes a strain gauge assembly 202 (e.g., strain gauge assembly 128), an amplifier 204, an analog-to-digital converter (ADC) 206, and processing circuitry 208. In some examples in which the torque measurement device 200 corresponds to electronic torque wrench 100, the amplifier ADC and processing circuitry may be components of the electronics unit 112, carried by the circuit board 136.

The strain gauge assembly 202 is configured to measure an applied torque such as the torque applied to a fastener when the torque measurement device 200 is an electronic torque wrench, and produce an analog electrical signal that varies in voltage with the torque. The amplifier 204 is configured to receive the analog electrical signal, and increase an amplitude of the analog electrical signal to produce an amplified, analog electrical signal.

The ADC 206 is configured to convert the amplified, analog electrical signal to an equivalent digital electrical signal. The processing circuitry 208, then, is configured to determine the torque value of the torque applied to the fastener from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

The processing circuitry 208 may output the indication of the torque value in a number of different manners. In some examples, the torque measurement device 200 further includes a digital display 210 (e.g., digital display 138), and the processing circuitry is configured to output the indication of the torque value to the digital display that is configured to display the torque value.

As also shown, the torque measurement device 200 may include a communication interface 212 is configured to enable the torque measurement device to telecommunicate with another apparatus by wire, or wirelessly by radio or optical communication. As described herein, the communication interface is an electronic circuit; and in various examples, the communication interface includes a cable connector, an antenna or optoelectronics for the electronic transmission of information over a data link between the apparatus and computer/computer hardware. Examples of suitable communication interfaces include a network interface controller (NIC), wireless NIC (WNIC) or the like.

To further illustrate calculation of the torque value according to various example implementations, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times r =0.002 and/=0.011 seconds, thereby producing a second equivalent digital value. At time t =0.012 seconds, the processing circuitry may average the digital data points taken between times/=0.003 seconds and t =0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

In some examples, the processing circuitry 208 may utilize the equivalent digital values and a calibration function to calculate the torque value. FIG. 3 is a graph 300 of a calibration function that includes a plurality of line segments for use by the processing circuitry to convert the digital values of the equivalent digital electrical signals into equivalent torque values, according to some example implementations. In this regard, after assembly, each torque measurement device 200 may be calibrated in order to derive the calibration function. The torque measurement device may be used to measure known applied torque values at various points along an interval of torque values ranging from 0 to 100% of a preset maximum torque. The data points for the interval of torque values provide three different line segments (302, 304 and 306) of the graph of which the slopes (m) and y-intercepts (b) can be found using the equation y=m(x)+b. The calibration function may be defined to include the linear functions for the line segments, which may be stored in memory and used by the processing circuitry to determine equivalent torque values based on the equivalent digital values.

As explained in the background section, programs that use an electronic torque wrench often include periodic recalibration, but a preset interval between recalibrations may not accurately reflect when recalibration is needed for a particular torque wrench. Example implementations of the present disclosure provide a system, apparatus and method whereby an interval between recalibration and a next recalibration of a torque measurement device is predicted based on a calibration function in use at the time of the recalibration, and a second calibration derived during the recalibration. This predicted interval may then be used to determine when to perform the next recalibration of the torque measurement device.

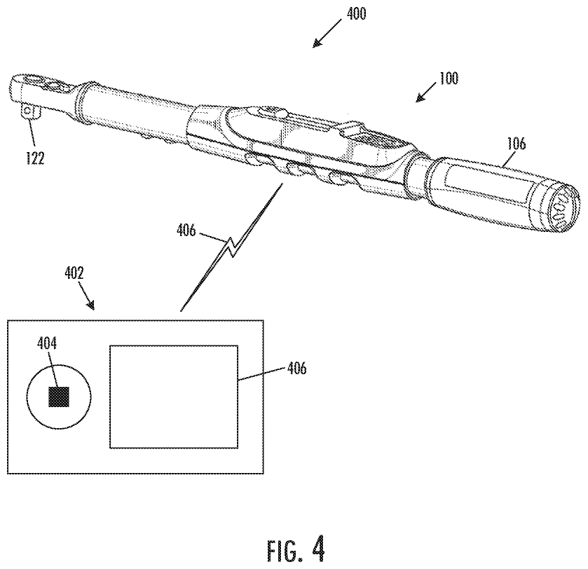

FIG. 4 illustrates a system 400 for calibrating a torque measurement device 200 such as an electronic torque wrench 100, according to various example implementations. According to various example implementations, the system includes the the torque mesaurement device and an apparatus for recalibrating the torque measurement device. The apparatus may be embodied in a number of different manners. In the example shown in FIG. 4 in which the torque measurement device is an electronic torque wrench, the apparatus may be embodied as a torque tester 402 that the electronic torque wrench is configured to engage. In this regard, the torque tester may include a female square drive or recess 404 configured to receive the boss 122 of the electronic torque wrench. In other examples, the apparatus may be embodied as the torque measurement device itself, such as based on its recalibration using the torque tester.

In various examples, the electronic torque wrench 100 is configured to determine a torque value of an applied torque using a calibration function derived during a calibration of the electronic torque wrench. The torque tester 402 is configured to perform a recalibration of the electronic torque wrench in which a second calibration function is derived and written to the electronic torque wrench.

During recalibration, in various examples, the electronic torque wrench 100 is engaged with the torque tester 402 and a rotational force is applied at the grip handle 106, which produces an applied torque at the torque tester. The electronic torque wrench is configured to produce a digital electrical signal that represents the applied torque as sequence of digital data points, and determine the torque value of the applied torque from the sequence of digital data points. The torque tester is configured to read the sequence of digital data points and the torque value from the electronic torque wrench, such as over a (wired or wireless) data link 406 between the electronic torque wrench and the torque tester 402.

The torque tester 402 is configured to measure the torque at the torque tester, and determine a corresponding reference torque value from the torque as measured at the torque tester, such as in a manner the same as or similar to the electronic torque wrench 100. The torque tester is configured to derive the second calibration function from the sequence of digital data points and the corresponding reference torque value. In some examples, the torque tester is configured to convert the sequence of digital data points to a digital value, and derive the second calibration function that maps the digital value to the corresponding reference torque value. More particularly, the torque tester may determine a subset of the digital data points in a moving sample window, and calculate the digital value from a rolling average of the subset of the digital data points in the moving sample window. The torque tester may then write the second calibration function to the electronic torque wrench, such as over the data link 406 between the electronic torque wrench and the torque tester.

In a more functional notation, the calibration function may include a line segment expressed as:

$$T = {f}_{0} ( AD ) = AD \times {k}_{0} + {T}_{00} \qquad ( 1 )$$

Similarly, the second calibration function may include a corresponding line segment expressed as:

$$T = {f}_{1} ( AD ) = AD \times {k}_{1} + {T}_{01} \qquad ( 2 )$$

In the above, the calibration function f₀ and the second calibration function f₁ both map digital value AD to a torque value T. The calibration function includes parameters k₀ and T₀₀, and the second calibration function includes corresponding parameters k₁ and T₀₁.

According to example implementations of the present disclosure, the torque tester 402 is configured to determine a deviation in the torque value determined using the calibration function relative to the second calibration function. The torque tester is configured to predict an interval from the recalibration to a next recalibration of the electronic torque wrench, for a different deviation over the next interval, based on the deviation, the different deviation, and the interval from the calibration to the recalibration. And the torque tester is configured to output an indication of the interval from the recalibration to the next recalibration. The different deviation over the next interval may be exablished in any of a number of different manners. In some examples, the different deviation is expressed as a percentage of the torque value determined from the digital value using the second calibration function. In one more particulr example, the different deviation is a rated accuracy of the electronic torque wrench, such as ±1% of the torque value T (i.e., ±0.01×T).

In some examples in which the electronic torque wrench 100 is configured to produce a digital electrical signal that represents the applied torque as sequence of digital data points, the torque tester 402 is configured to determine the deviation from the digital value to which the sequence of digital data points are converted. In some further examples, the torque tester is configured to determine the torque value from the digital value using the second calibration function, determine a corresponding torque value from the digital value using the calibration function, and determine the deviation as a difference between the torque value and the corresponding torque value.

To further illustrate the above, the torque value T may be determined from digital value AD using the calibration function (1), and a corresponding torque value T″ may be determined from the digital value AD using the second calibration function (2). A deviation then be determined from the torque value and the corresponding torque value as follows:

$${T}_{err} = \vert T ’ - T \vert \qquad ( 3 )$$

In (3) above, Tₑᵣᵣ represents the deviation in the torque value determined using the calibration function and the second calibration function.

In a similar manner, in some examples, the torque tester 402 configured to determine the deviation includes the torque tester configured to apply the digital value to a difference between the second calibration function and the calibration function. In this regard, the deviation Tₑᵣᵣ may be expressed as a function of the digial value as follows:

$$\begin{matrix}{T}_{err} ( AD ) = {f}_{1} ( AD ) - {f}_{0} ( AD ) \\ = AD \times \vert {k}_{1} - {k}_{0} \vert + \vert {T}_{01} - {T}_{00} \vert\end{matrix} \qquad ( 4 )$$

The interval from the recalibration to the next recalibration may also be predicted in a number of different manners. In some examples, predicting the interval from the recalibration to the next recalibration includes determine a constant of proportionality that expresses a proportional relationship between the interval and the deviation in the torque value. And in some of these examples, the torque tester 402 is configured to calculate the interval from the recalibration to the next recalibration based on a product of the constant of proportionality and the different deviation. In a more notational example in which n represents the interval, a constant of proportionality may be determined as n/Tₑᵣᵣ, and the interval nₓ from the recalibration to the next recalibration may be determined as follows:

$${{n}_{x} = ( n / {T}_{err} ) \times T ’}_{err} \qquad ( 5 )$$

In (5), T′ₑᵣᵣ represents the different deviation such as ±0.01×T.

In some examples, the indication of the interval from the recalibration to the next recalibration is output to an electronic visual display on which the indication is displayed. In this regard, the torque tester 402 may include an electronic visual display 406 on which the indication is displayed. Additionally or alternatively, the indication may be displayed by a digital display 138 of the electronic torque wrench 100. This may be the case when the apparatus is embodied as the electronic torque wrench, or the torque tester may send the interval to the electronic torque wrench (e.g., over the data link 406) for display on the digital display of the electronic toque wrench.

In some examples, the interval is measured in time or use of the electronic torque wrench 100, and the torque tester is further configured to track the time or use of the electronic torque wrench from the recalibration. In some of these examples, the torque tester 402 is configured to output an alert for the next recalibration when the time or use as tracked is within a threshold of the interval from the recalibration to the next recalibration. The alert may be output in a number of different manners, such as to an electronic visual display (e.g., digital display 138, electronic visual display 406) on which the alert is displayed.

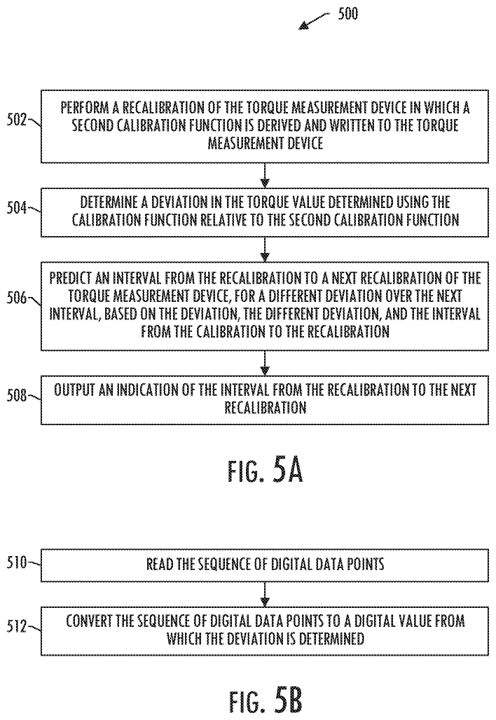

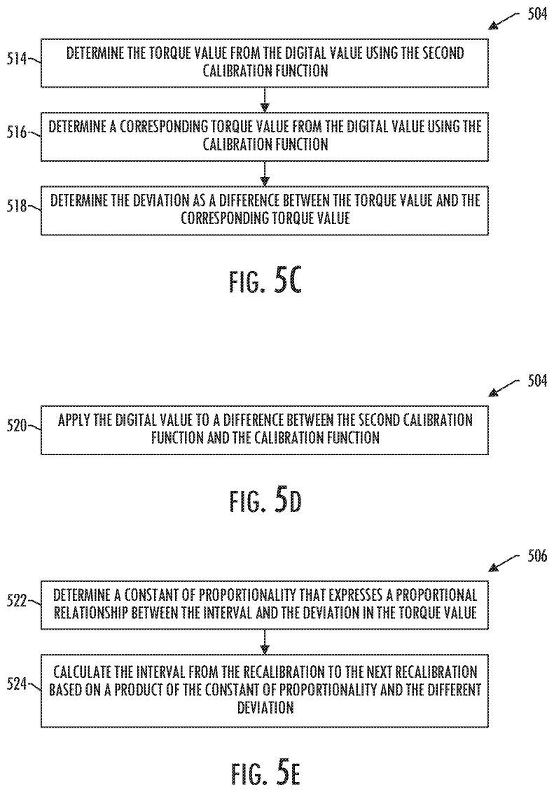

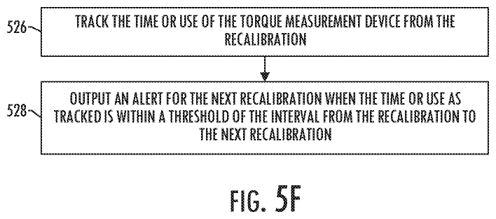

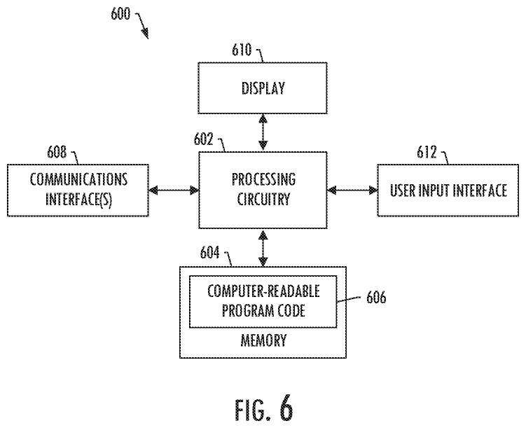

FIGS. 5A-5F are flowcharts illustrating various steps in a method 500 of recalibrating an torque measurement device configured to determine a torque value of an applied torque using a calibration function derived during a calibration of the torque measurement device, according to various example implementations. The method includes performing a recalibration of the torque measurement device in which a second calibration function is derived and written to the torque measurement device, as shown at block 502 of FIG. 5A. The method includes determining a deviation in the torque value determined using the calibration function relative to the second calibration function, as shown at block 504. The method includes predicting an interval from the recalibration to a next recalibration of the torque measurement device, for a different deviation over the next interval, based on the deviation, the different deviation, and the interval from the calibration to the recalibration, as shown at block 506. And the method includes outputting an indication of the interval from the recalibration to the next recalibration, as shown at block 508.

In some examples, the torque measurement device is configured to produce a digital electrical signal that represents the applied torque as sequence of digital data points. In some of these examples, the method further includes reading the sequence of digital data points, as shown at block 510 of FIG. 5B. And the method includes converting the sequence of digital data points to a digital value from which the deviation is determined, as shown at block 512.

In some examples, determining the deviation at block 504 includes determining the torque value from the digital value using the second calibration function, as shown at block 514 of FIG. SC. A corresponding torque value is determined from the digital value using the calibration function, as shown at block 516. And the deviation is determined as a difference between the torque value and the corresponding torque value, as shown at block 518.

In some examples, determining at block 504 the deviation includes applying the digital value to a difference between the second calibration function and the calibration function, as shown at block 520 of FIG. 5D.

In some examples, the different deviation is expressed as a percentage of the torque value determined from the digital value using the second calibration function.

In some examples, predicting the interval from the recalibration to the next recalibration at block 506 includes determining a constant of proportionality that expresses a proportional relationship between the interval and the deviation in the torque value, as shown at block 522 of FIG. 5E. In some of these examples, the interval is calculated from the recalibration to the next recalibration based on a product of the constant of proportionality and the different deviation, as shown at block 524.

In some examples, the torque measurement device is an electronic torque wrench, the applied torque is a torque applied by the electronic torque wrench to a torque tester with which the electronic torque wrench is engaged.

In some examples, the torque measurement device is an electronic torque wrench, the applied torque is a torque applied by the electronic torque wrench to a torque tester with which the electronic torque wrench is engaged, and the method is performed by the electronic torque wrench.

In some examples, the indication of the interval from the recalibration to the next recalibration is output at block 508 to an electronic visual display on which the indication is displayed.

In some examples, the interval is measured in time or use of the torque measurement device. In some of these examples, the method 500 further includes tracking the time or use of the torque measurement device from the recalibration, as shown at block 526 of FIG. 5F. And the method includes outputting an alert for the next recalibration when the time or use as tracked is within a threshold of the interval from the recalibration to the next recalibration, as shown at block 528.

In some further examples, the alert is output at block 528 to an electronic visual display on which the alert is displayed.

According to example implementations of the present disclosure, the apparatus for calibrating a torque measurement device may be implemented by various means. Means for implementing the apparatus may include hardware, alone or under direction of one or more computer programs from a computer-readable storage medium. In some examples, one or more apparatuses may be configured to function as or otherwise implement the apparatus shown and described herein. In examples involving more than one apparatus, the respective apparatuses may be connected to or otherwise in communication with one another in a number of different manners, such as directly or indirectly via a wired or wireless network or the like.

FIG. 6 illustrates an apparatus 600 that may be embodied by the torque measurement device 200 (e.g., electronic torque wrench 100) or torque tester 402, according to some example implementations of the present disclosure. Generally, an apparatus of exemplary implementations of the present disclosure may comprise, include or be embodied in one or more fixed or portable electronic devices. The apparatus may include one or more of each of a number of components such as, for example, processing circuitry 602 (e.g., processing circuitry 208) connected to a memory 604.

The processing circuitry 602 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

The memory 604 is generally any piece of computer hardware that is capable of storing information such as, for example, data, computer programs (e.g., computer-readable program code 606) and/or other suitable information either on a temporary basis and/or a permanent basis. The memory may include volatile and/or non-volatile memory, and may be fixed or removable. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 604, the processing circuitry 602 may also be connected to one or more interfaces for displaying, transmitting and/or receiving information. The interfaces may include a communications interface 608 (e.g., communication interface 212) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a NIC, WNIC or the like.

The user interfaces may include a display 610 (e.g., digital display 138, electronic visual display 406) and/or one or more user input interfaces 612 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like.

As explained above and reiterated below, the present disclosure includes, without limitation, the following example implementations.

Clause 1. An apparatus for recalibrating an torque measurement device configured to determine a torque value of an applied torque using a calibration function derived during a calibration of the torque measurement device, the apparatus comprising: a memory configured to store computer-readable program code; and processing circuitry configured to access the memory, and execute the computer-readable program code to cause the apparatus to at least: perform a recalibration of the torque measurement device in which a second calibration function is derived and written to the torque measurement device; determine a deviation in the torque value determined using the calibration function relative to the second calibration function; predict an interval from the recalibration to a next recalibration of the torque measurement device, for a different deviation over the next interval, based on the deviation, the different deviation, and the interval from the calibration to the recalibration; and output an indication of the interval from the recalibration to the next recalibration.

Clause 2. The apparatus of clause 1, wherein the torque measurement device is configured to produce a digital electrical signal that represents the applied torque as sequence of digital data points, and the processing circuitry is configured to execute the computer-readable program code to cause the apparatus to further at least: read the sequence of digital data points; and convert the sequence of digital data points to a digital value from which the deviation is determined.

Clause 3. The apparatus of clause 2, wherein the apparatus caused to determine the deviation includes the apparatus caused to: determine the torque value from the digital value using the second calibration function; determine a corresponding torque value from the digital value using the calibration function; and determine the deviation as a difference between the torque value and the corresponding torque value.

Clause 4. The apparatus of clause 2 or clause 3, wherein the apparatus caused to determine the deviation includes the apparatus caused to apply the digital value to a difference between the second calibration function and the calibration function.

Clause 5. The apparatus of any of clauses 2 to 4, wherein the different deviation is expressed as a percentage of the torque value determined from the digital value using the second calibration function.

Clause 6. The apparatus of any of clauses 1 to 5, wherein predicting the interval from the recalibration to the next recalibration includes: determine a constant of proportionality that expresses a proportional relationship between the interval and the deviation in the torque value; and calculate the interval from the recalibration to the next recalibration based on a product of the constant of proportionality and the different deviation.

Clause 7. The apparatus of any of clauses 1 to 6, wherein the torque measurement device is an electronic torque wrench, the applied torque is a torque applied by the electronic torque wrench to a torque tester with which the electronic torque wrench is engaged, and the apparatus is embodied as the torque tester.

Clause 8. The apparatus of any of clauses 1 to 7, wherein the torque measurement device is an electronic torque wrench, the applied torque is a torque applied by the electronic torque wrench to a torque tester with which the electronic torque wrench is engaged, and the apparatus is embodied as the electronic torque wrench.

Clause 9. The apparatus of any of clauses I to 8, wherein the indication of the interval from the recalibration to the next recalibration is output to an electronic visual display on which the indication is displayed.

Clause 10. The apparatus of any of clauses 1 to 9, wherein the interval is measured in time or use of the torque measurement device, and processing circuitry is configured to execute the computer-readable program code to cause the apparatus to further at least: track the time or use of the torque measurement device from the recalibration; and output an alert for the next recalibration when the time or use as tracked is within a threshold of the interval from the recalibration to the next recalibration.

Clause 11. The apparatus of clause 10, wherein the alert is output to an electronic visual display on which the alert is displayed.

Clause 12. A method of recalibrating an torque measurement device configured to determine a torque value of an applied torque using a calibration function derived during a calibration of the torque measurement device, the method comprising: performing a recalibration of the torque measurement device in which a second calibration function is derived and written to the torque measurement device; determining a deviation in the torque value determined using the calibration function relative to the second calibration function; predicting an interval from the recalibration to a next recalibration of the torque measurement device, for a different deviation over the next interval, based on the deviation, the different deviation, and the interval from the calibration to the recalibration; and outputting an indication of the interval from the recalibration to the next recalibration.

Clause 13. The method of clause 12, wherein the torque measurement device is configured to produce a digital electrical signal that represents the applied torque as sequence of digital data points, and the method further comprises: reading the sequence of digital data points; and converting the sequence of digital data points to a digital value from which the deviation is determined.

Clause 14. The method of clause 13, wherein determining the deviation includes: determining the torque value from the digital value using the second calibration function; determining a corresponding torque value from the digital value using the calibration function; and determining the deviation as a difference between the torque value and the corresponding torque value.

Clause 15. The method of clause 13 or clause 14, wherein determining the deviation includes applying the digital value to a difference between the second calibration function and the calibration function.

Clause 16. The method of any of clauses 13 to 15, wherein the different deviation is expressed as a percentage of the torque value determined from the digital value using the second calibration function.

Clause 17. The method of any of clauses 12 to 16, wherein predicting the interval from the recalibration to the next recalibration includes: determining a constant of proportionality that expresses a proportional relationship between the interval and the deviation in the torque value; and calculating the interval from the recalibration to the next recalibration based on a product of the constant of proportionality and the different deviation.

Clause 18. The method of any of clauses 12 to 17, wherein the torque measurement device is an electronic torque wrench, the applied torque is a torque applied by the electronic torque wrench to a torque tester with which the electronic torque wrench is engaged.

Clause 19. The method of any of clauses 12 to 18, wherein the torque measurement device is an electronic torque wrench, the applied torque is a torque applied by the electronic torque wrench to a torque tester with which the electronic torque wrench is engaged, and the method is performed by the electronic torque wrench.

Clause 20. The method of any of clauses 12 to 19, wherein the indication of the interval from the recalibration to the next recalibration is output to an electronic visual display on which the indication is displayed.

Clause 21. The method of any of clauses 12 to 20, wherein the interval is measured in time or use of the torque measurement device, and method further comprises: tracking the time or use of the torque measurement device from the recalibration; and outputting an alert for the next recalibration when the time or use as tracked is within a threshold of the interval from the recalibration to the next recalibration.

Clause 22. The method of clause 21, wherein the alert is output to an electronic visual display on which the alert is displayed.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for recalibrating an torque measurement device configured to determine a torque value of an applied torque using a calibration function derived during a calibration of the torque measurement device, the apparatus comprising:
a memory configured to store computer-readable program code; and
processing circuitry configured to access the memory, and execute the computer-readable program code to cause the apparatus to at least:
perform a recalibration of the torque measurement device in which a second calibration function is derived and written to the torque measurement device;
determine a deviation in the torque value determined using the calibration function relative to the second calibration function;
predict an interval from the recalibration to a next recalibration of the torque measurement device, for a different deviation over the next interval, based on the deviation, the different deviation, and the interval from the calibration to the recalibration; and
output an indication of the interval from the recalibration to the next recalibration.

2. The apparatus of claim 1, wherein the torque measurement device is configured to produce a digital electrical signal that represents the applied torque as sequence of digital data points, and the processing circuitry is configured to execute the computer-readable program code to cause the apparatus to further at least:
read the sequence of digital data points; and
convert the sequence of digital data points to a digital value from which the deviation is determined.

3. The apparatus of claim 2, wherein the apparatus caused to determine the deviation includes the apparatus caused to:
determine the torque value from the digital value using the second calibration function;
determine a corresponding torque value from the digital value using the calibration function; and
determine the deviation as a difference between the torque value and the corresponding torque value.

4. The apparatus of claim 2, wherein the apparatus caused to determine the deviation includes the apparatus caused to apply the digital value to a difference between the second calibration function and the calibration function.

5. The apparatus of claim 2, wherein the different deviation is expressed as a percentage of the torque value determined from the digital value using the second calibration function.

6. The apparatus of claim 1, wherein predicting the interval from the recalibration to the next recalibration includes:
determine a constant of proportionality that expresses a proportional relationship between the interval and the deviation in the torque value; and
calculate the interval from the recalibration to the next recalibration based on a product of the constant of proportionality and the different deviation.

7. The apparatus of claim 1, wherein the torque measurement device is an electronic torque wrench, the applied torque is a torque applied by the electronic torque wrench to a torque tester with which the electronic torque wrench is engaged, and the apparatus is embodied as the torque tester.

8. The apparatus of claim 1, wherein the torque measurement device is an electronic torque wrench, the applied torque is a torque applied by the electronic torque wrench to a torque tester with which the electronic torque wrench is engaged, and the apparatus is embodied as the electronic torque wrench.

9. The apparatus of claim 1, wherein the indication of the interval from the recalibration to the next recalibration is output to an electronic visual display on which the indication is displayed.

10. The apparatus of claim 1, wherein the interval is measured in time or use of the torque measurement device, and processing circuitry is configured to execute the computer-readable program code to cause the apparatus to further at least:
track the time or use of the torque measurement device from the recalibration; and
output an alert for the next recalibration when the time or use as tracked is within a threshold of the interval from the recalibration to the next recalibration.

11. A method of recalibrating an torque measurement device configured to determine a torque value of an applied torque using a calibration function derived during a calibration of the torque measurement device, the method comprising:
performing a recalibration of the torque measurement device in which a second calibration function is derived and written to the torque measurement device;
determining a deviation in the torque value determined using the calibration function relative to the second calibration function;
predicting an interval from the recalibration to a next recalibration of the torque measurement device, for a different deviation over the next interval, based on the deviation, the different deviation, and the interval from the calibration to the recalibration; and
outputting an indication of the interval from the recalibration to the next recalibration.

12. The method of claim 11, wherein the torque measurement device is configured to produce a digital electrical signal that represents the applied torque as sequence of digital data points, and the method further comprises:
reading the sequence of digital data points; and
converting the sequence of digital data points to a digital value from which the deviation is determined.

13. The method of claim 12, wherein determining the deviation includes:
determining the torque value from the digital value using the second calibration function;
determining a corresponding torque value from the digital value using the calibration function; and
determining the deviation as a difference between the torque value and the corresponding torque value.

14. The method of claim 12, wherein determining the deviation includes applying the digital value to a difference between the second calibration function and the calibration function.

15. The method of claim 12, wherein the different deviation is expressed as a percentage of the torque value determined from the digital value using the second calibration function.

16. The method of claim 11, wherein predicting the interval from the recalibration to the next recalibration includes:
determining a constant of proportionality that expresses a proportional relationship between the interval and the deviation in the torque value; and
calculating the interval from the recalibration to the next recalibration based on a product of the constant of proportionality and the different deviation.

17. The method of claim 11, wherein the torque measurement device is an electronic torque wrench, the applied torque is a torque applied by the electronic torque wrench to a torque tester with which the electronic torque wrench is engaged.

18. The method of claim 11, wherein the torque measurement device is an electronic torque wrench, the applied torque is a torque applied by the electronic torque wrench to a torque tester with which the electronic torque wrench is engaged, and the method is performed by the electronic torque wrench.

19. The method of claim 11, wherein the indication of the interval from the recalibration to the next recalibration is output to an electronic visual display on which the indication is displayed.

20. The method of claim 11, wherein the interval is measured in time or use of the torque measurement device, and method further comprises:
tracking the time or use of the torque measurement device from the recalibration; and
outputting an alert for the next recalibration when the time or use as tracked is within a threshold of the interval from the recalibration to the next recalibration.
